(19) United States
(12) Patent Application Publication
(10) Pub. No.: US 2026/0150126 A1
(43) Pub. Date: May 28, 2026

(54) AUTOMATED WIRELESS TRANSMISSION SENSING AND SCANNING LOGIC

(71) Applicant: Ekahau Oy, Helsinki (FI)

(72) Inventors: Mikko LAURONEN, Helsinki (FI); Ari TOURUNEN, Espoo (FI)

(21) Appl. No.: 18/995,727

(22) PCT Filed: Jun. 16, 2023
(86) PCT No.: PCT/FI2023/050359

§ 371 Date: Jan. 16, 2025

Related U.S. Application Data
(60) Provisional application No. 63/392,036, filed on Jul. 25, 2022.

(51) Int. Cl. H04W 74/0808; H04W 84/12

(52) U.S. Cl. CPC H04W 74/0808; H04W 84/12

(57) ABSTRACT

A device includes one or more radios, and a processing device that is configured to determine (304) whether a channel of a wireless network has activity. in response to the channel having activity, the processing device operates (308) the one or more radios to sense a signal strength of the channel. one or more techniques may be implemented to quickly determine that the channel is active, without scanning the each and every channel of the wireless channel with the one or more radios.

### BACKGROUND

A wireless network may include computing devices (e.g., nodes) that communicate with each other using wireless data connections. Each node may have a transmitter or receiver that communicates with the network over radio frequencies (RF). A wireless local area network (WLAN) links two or more devices through an access point (AP). An access point typically connects to a wired router, switch, or hub via an Ethernet cable, and projects a signal (e.g., a Wi-Fi signal) that covers a given region. For example, an access point may be installed in a living room to provide network coverage in the living room and surrounding areas.

A typical wireless network may include one or more access points that provide wireless access to nodes over a given region. A network planning tool may be used for wireless network planning. Multi-band access points are physical access points that may include multiple radios operating in different frequencies. A network planning tool may help a user determine the number of APs and locations of APs. A user may wish to determine an optimal number of APs and locations with as few APs as possible, to facilitate deployment and maintenance, for example. A network planning tool (e.g., a measurement tool) may be used to determine whether coverage is sufficient at various locations of a given space.

### SUMMARY

This disclosure relates to a network planning tool such as a computing device, that may measure signal strength of a network. The device may measure the signal strength of channels in a selective and efficient manner.

In one aspect, a computing device (e.g., a network planning tool) comprises one or more radios and a processing device. The processing device is configured to determine whether a channel of a wireless network has activity. In response to the channel having activity, the processing device operates the one or more radios to sense a signal strength of the channel. The processing device may determine one or more active channels in the wireless network, and target those channels, and not others, for sensing signal strength.

In some embodiments, to determine whether the channel has activity, the processing device obtains a list of one or more channels that are active on a 6 GHZ frequency band. This may be obtained over different frequency band, e.g., over a 2.4 GHz frequency band or a 5 GHz frequency band. Obtaining the list of the one or more channels may include obtaining a beacon frame from an access point over the 2.4 GHz frequency band or the 5 GHz frequency band. The beacon frame may include the list of one or more active channels on the 6 GHz frequency band.

In some embodiments, the processing device operates the one or more radios to sense the signal strength of the channel on the 6 GHz frequency band without sensing the signal strength of inactive channels on the 6 GHz frequency band. More generally, in some embodiments, the processing device may operate the one or more radios to ignore (e.g., skip) each of the channels (e.g., one or more second channels) in response to determining that those channels do not have activity.

In some embodiments, determining whether the channel is active includes obtaining, from an access point, a list of active channels of neighboring access point on the wireless network.

In some embodiments, the device further includes a spectrum analyzer. Determining whether the channel is active may include sweeping one or more frequency bands with the spectrum analyzer to determine that the channel in the one or more frequency bands has activity.

In some embodiments, the processing devices is configured to sense a signal strength on a default set of channels. This may be performed for a list of commonly used channels. In some embodiments, the radios may be operated to listen on default channels to determine which of the channels have activity and which do not, to determine which channels to scan.

In some embodiments, the wireless network is a wireless local area network (WLAN). For example, the wireless network may operate as a Wi-Fi network or otherwise use an IEEE 802 protocol.

In some embodiments, the device is a portable device with local energy storage (e.g., a battery). A user may transport the device without hindrance (e.g., power cables), to freely measure various locations in a given space. The device may include a handle or a strap. The device may be sized to easily be transported (e.g., carried by hand) from one location to another.

The above summary does not include an exhaustive list of all aspects of the present disclosure. It is contemplated that the disclosure includes all systems and methods that can be practiced from all suitable combinations of the various aspects summarized above, as well as those disclosed in the Detailed Description below and particularly pointed out in the Claims section. Such combinations may have advantages not specifically recited in the above summary.

### BRIEF DESCRIPTION OF THE DRAWINGS

Several aspects of the disclosure here are illustrated by way of example and not by way of limitation in the figures of the accompanying drawings in which like references indicate similar elements. It should be noted that references to “an” or “one” aspect in this disclosure are not necessarily to the same aspect, and they mean at least one. Also, in the interest of conciseness and reducing the total number of figures, a given figure may be used to illustrate the features of more than one aspect of the disclosure, and not all elements in the figure may be required for a given aspect.

FIG. 1 shows an example of a computing device, in accordance with some embodiments.

FIG. 2 shows an example of a computing device that measures network coverage, in accordance with some embodiments.

FIG. 3 illustrates a method for determining a network signal strength, in accordance with some embodiments.

FIG. 4 illustrates a method for determining a network signal strength with various techniques, in accordance with some embodiments.

### DETAILED DESCRIPTION

Wi-Fi utilizes some of the IEEE 802 protocol family and interacts seamlessly with Ethernet, a wired networking technology and standard. Wi-Fi enabled devices can connect to the network through a wireless access point, which may be a multi-band wireless access point. The network provides communication between devices on the network, as well as the Internet. Various versions of Wi-Fi are specified by various IEEE 802.11 protocol standards. The different radio technologies determine the radio bands, the maximum ranges, and the speeds that may be achieved through the network.

Frequency bands (e.g., 2.4 GHz, 5 GHZ, or 6 GHZ) are ranges of radio wave frequencies used to transmit data in the wireless spectrum, and can further be broken down into Wi-Fi channels. Wi-Fi may use 2.4 GHz (120 mm) UHF and 5 GHZ (60 mm) SHF radio frequency bands. Wi-Fi has also expanded to include a 6 gigahertz frequency band. These bands are subdivided into multiple channels that each occupy a frequency range in its respective frequency band. With the expansion of WLAN (e.g., into the 6 GHz frequency band), the total number of channels grows larger.

Conventional wireless scanning tools scan each and every channel of a wireless network to determine signal strength of the wireless network. Not every channel of a wireless channel, however, has signal activity. Scanning on such a channel without signal activity does not provide a useful measure of the signal strength on that channel. As such, scanning each and every channel of a wireless network, without regard to whether or not the channel has signal activity, needlessly consumes time and resources of the wireless scanning tool. This issue is exacerbated as the number of available wireless network channels continues to grow. For example, the 6 GHz band represents 1200 MHz of spectrum that will be available from 5.925 GHz to 7.125 GHz. Knowing that 2.4 GHz band only had 11 channels, with the new spectrum, Wi-Fi may have access to 59 20-MHz channels, 29 40-MHz channels, 14 80-MHz channels, and 7 160-MHz channels. Without an intelligent scanning logic, conventional scanning solutions will scan every available wireless channel, resulting in a slow measurement process. Some measurement tools may compensate by increasing the number of radios on the tool, which may result in a large and cumbersome tool that needlessly consumes power.

Aspects of the present disclosure may utilize a standardized 6 GHz wireless network (e.g., a Wi-Fi network discovery method) which may be referred to as out-of-band discovery. This method allows network clients to quickly discover the presence of 6 GHz Wi-Fi access points from commonly available 2.4 GHz and 5 GHz beacon advertisements. In case an AP also operates on the 6 GHz frequency band, it can advertise it on the 2.4 GHz or 5 GHz beacons, or both, so that the client can quickly discover availability of 6 GHz channels. Such a method is traditionally used to improve network discovery for a client trying to access out of band channels, but not for other purposes. Aspects of the present disclosure may use this technique to efficiently select which channels to focus on (e.g., in the 6 GHz frequency band) for measuring signal strength.

With an automated wireless transmission sensing, a measuring device according to the present disclosure may focus only on those frequencies where there are wireless transmissions, and skip the others. This enables fewer measurement radios to be used and the device can be smaller and lighter in size. Respectively, the automated wireless sensing technique allows to measure signal strengths much faster and collect data of importance, thereby improving the accuracy of the signal strength measurements.

In some aspects, a device includes one or more radios and a processing device that is configured to determine whether one or more channels of a wireless network have activity. In response to the one or more channels having activity, the processing device operates the one or more radios to sense a signal strength of the channel.

The device may utilize multiple different methods to decide whether a frequency should be scanned and measured or whether it is to be skipped. In some examples, the device may scan and measure only a very small set of frequencies (e.g., a default set of frequencies) which makes the overall performance very fast and accurate. With this limited scanning, wireless transmission sensing of the device may indicate there are potentially additional frequencies to scan. The device may then automatically focus on those additional frequencies, and ignore others.

In some examples, in a 6 GHz enabled network, the automated wireless transmission sensing of the device could utilize ‘out-of-band discovery’ where the presence of 6 GHz access point is advertised within the 2.4 GHz and 5 GHz beacon frames. The device may sense a beacon frame transmitted from an AP over 2.4 GHZ and 5 GHz frequency. The device may decode the beacon frame which indicated to the device that the AP is also operating on 6 GHZ, and on what channel the AP is operating on in the 6 GHz frequency band. In response, the scanning logic of the device may automatically (e.g., perform without human intervention) operate its radios to scan that a channel on 6 GHz.

The smart sense scanning logic of the device may also utilize the neighbor announcements sent by the access points. These packets may be used by Wi-Fi clients to make efficient roaming decisions. This way the measurement device may obtain on which frequencies (e.g., channels) the Wi-Fi network is operating and can focus on those frequencies and not others.

The automated wireless transmission sensing of the device may also utilize a spectrum analyzer to identify if there is any RF activity which should be potentially scanned and measured by the device's radios. A spectrum analyzer may scan all frequencies used in a wireless network in a very fast manner (compared to the radios), but the spectrum analyzer may be unable to identify the kind of wireless transmission the RF activity is, much less decode it. As soon as the spectrum analyzer identifies there is RF activity on a certain frequency, the device may automatically adjust its Wi-Fi radios to scan and measure those frequencies (or channels that correspond to those frequencies) for wireless transmissions.

A device may utilize one or more of such techniques to determine whether a channel has activity. In some embodiments, the device may include logic that selects which of the techniques to use. The device may determine or estimate which channels have activity and scan those channels, and not others, to manage time and resources efficiently.

Thus, aspects of the present disclosure use an approach that may significantly speed up the wireless scanning process. Such an approach improves the efficiency of wireless transmission discovery and enables the use of fewer dedicated measurement radios which may make the portable measurement device less complex, smaller, lighter to carry, and more energy efficient.

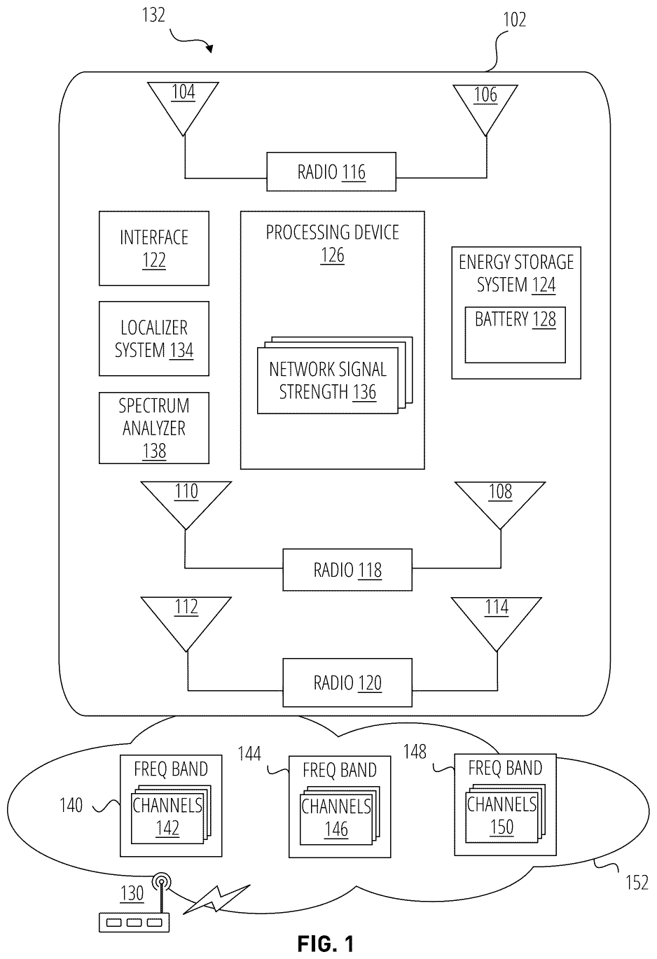

FIG. 1 shows an example of a computing device 132, in accordance with some embodiments. The computing device 132 may perform some or all of the operations or methods described. The computing device 132 may be understood as a network planning tool or as a network measurement device. In some examples, the network measurement device may be a portable measuring device (e.g., a handheld device, or a wearable device).

The computing device 132 may include one or more radios such as radios 116, 118, and 120, and a processing device 126. Each radio may include one or more antennas such as antennas 104, 106, 110, 108, 112, and 114. Each antenna may generate a respective electric signal containing sensed RF energy in the environment of the device. For example, each antenna may sense communications transmitted by access points such as access point 130 over one or more channels. Each antenna may also sense noise, which may be understood as RF energy coming from a non-network source or from a different wireless network.

Each of the radios 116, 118, and 120 may be operated to receive the electric signal from its respective one or more antennas and extract information on a particular channel (e.g., at a frequency or frequency range corresponding to the channel). The radio may sense the signal energy (e.g., a signal strength) of that channel. Signal strength may be determined as a measured amplitude of RF energy at a given frequency range corresponding to the channel. In some examples, signal strength may include a ratio such as a signal to noise ratio that compares the signal strength of a communication with the amount of noise energy picked up. In some instances, the radio may decode one or more messages over a channel, e.g., by decoding the communication through a known protocol. In some examples, as described, a decoded communication from an AP may be used to determine which channels have activity.

Each of the radios 116, 118, and 120 may include a Wi-Fi receiver (e.g., a Wi-Fi compatible receiver) that can sense signals on one or more Wi-Fi channels over a Wi-Fi network. The receivers may be compatible with WLAN standards 802.11n, 802.11g, 802.11b and 802.11a, to measure information in networks of the corresponding standards. In other embodiments, the receivers may be compatible with another standard.

Processing device 126 may include processing logic such as hardware (e.g., an electronic circuit, electronic components, passive components, active components, dedicated logic, programmable logic, a processor, a central processing unit (CPU), memory, a system-on-chip (SoC), etc.), software (e.g., instructions running/executing on a processing device), firmware (e.g., microcode), or a combination thereof. Processing device 126 may be standalone within the computing device 132, or distributed through various other components, or both. For example, each radio may comprise some or all of the processing logic that forms processing device 126. Processing device 126 may include one or more processors that execute software instructions stored on non-volatile memory to operate the device 132 and its various components as described.

The processing device 126 may be configured to determine whether a channel of a wireless network has activity. For example, the processing device may operate the radios to scan a limited range of default channels to obtain information about which of the channels in the network are active.

A channel of the wireless network 152 may be a predefined (e.g., standardized) frequency range of a frequency band. For example, a wireless network may include a first frequency band 140 that is subdivided into dedicated frequency ranges that each represent one of channels 142. The wireless network may include a second frequency band 144 that similarly has a second set of channels 146, and a third frequency band 148 that has a third set of channels 150. Access point 130 may include multiple radios, each dedicated to communicating over one of the frequency bands 140, 144, or 148. An access point with three radios may be referred to as a tri-band access point.

One or more default channels may be scanned to perform ‘out-of-band discovery’. The processing device 126 may obtain, from the first frequency band 140 (e.g., a 2.4 GHz frequency band) or from the second frequency band 144 (e.g., a 5 GHZ frequency band), a list of one or more channels that are active on the third frequency band 148 (e.g., a 6 GHz frequency band). The processing device 126 may listen on a default channel in the first frequency band 140 or the second frequency band 144 to obtain such a list.

In some examples, obtaining the list of the one or more channels includes obtaining a beacon frame from access point 130 over the first frequency band 140 or the second frequency band 144. The beacon frame may include the list of one or more active channels on the third frequency band 148. A beacon frame may be referred to as a management frame, and may be standardized in IEEE 802.11 based WLANs. Beacon frames may be transmitted periodically by access point 130 to announce the presence of a wireless LAN and to synchronize the members of the service set. Beacon frames may be transmitted by the access point (AP) in an infrastructure basic service set (BSS). Access point 130 may inform a client that probes the first frequency band 140 or the second frequency band 144 about the existence of the third frequency band 148 and provide information as to which of channels 150 in the third frequency band 148 are active. As such, computing device 132 may actively probe one or more default channels in channels 142 or channels 146 to obtain which of channels 150 are active.

Additionally, or alternatively, processing device 126 may obtain, from access point 130, a list of active channels of one or more neighboring access points on the wireless network. Wireless Local Area Network (WLAN) Radio Measurements may include protocols that allow an AP or client to obtain information to better understand the wireless network environment. A device such as computing device 132 may obtain such information from access point 130.

Conventionally, such a feature may be used by a device to preserve the QoE (Quality of Experience) for an end user. For example, in order to preserve the QoE for applications such as VoIP and video streaming, WLAN Radio Measurements may be used by a client device (e.g., a node) to collect information from the AP that it is currently connected to, prior to that client device re-associating to a new and different AP. This can reduce the time of the device to reconnect from one AP to another AP in the same wireless network. In such a scheme, a requesting device may send a ‘neighbor report’ request to an AP such as access point 130. The AP may return a ‘neighbor report’ that contains information about neighboring APs in the same wireless network, and channel information about each of those neighboring APs (e.g., a last known operating channel of the neighboring AP). Instead of the client engaging in time consuming scanning activity (either actively probing for APs or passively listening to every channel for beacons) the client can instead narrow its list down to the known available neighbors. The neighbor report may identify one or more neighboring APs and one or more channels operating on the neighbor APs. In such a manner, the neighbor report feature enables the client to collect information about the neighboring APs of the AP it is currently associated to, and this information may be used by the client to quickly identify potential candidates for a new point of attachment.

Computing device 132 may leverage the neighbor reporting feature of APs to quickly sense signal strengths of channels. Processing device 126 may operate the radios 116, 118, or 120, or a combination thereof, to obtain the neighbor report from a default channel of an AP (e.g., AP 130). Processing device 126 may treat each of the last known operating channels of the neighboring APs as channels that have activity. Computing device 132 may operate the radios 116, 118, or 120 to sense the signal strength on these channels. In such a manner, computing device 132 may use such information shared by APs to determine a list of active channels in the wireless network, and focus on those channels, and not others.

Additionally, or alternatively, the computing device 132 may use a spectrum analyzer 138 to determine which channels in the wireless network 152. Computing device 132 may operate the spectrum analyzer 138 to sweep one or more frequency bands (e.g., frequency band 140, frequency band 144, frequency band 148, or a combination thereof) to determine which among the channels 142, 146, and 150 have activity.

The spectrum analyzer 138 may be operated to gather information on radio frequency distribution to detect disturbance (interference) on the radio frequency. When examining a WLAN network, the spectrum analyzer 138 may be operated to listen to network traffic on the WLAN frequency ranges dedicated to each channel, to detect active channels and to measure signal strengths, noise levels, and mutual disturbance of channel signals. Disturbance may be caused by non-WLAN standard devices operating on the same radio frequency or affecting the radio frequency, such as wireless phones, Bluetooth devices, Zig Bee devices, microwave ovens, etc.

In one example, the spectrum analyzer 138 is a fast, high-resolution spectrum analyzer, comprising a wideband receiver. The spectrum analyzer 138 may be operated to process sensed information at a rate that accommodates up to 25 sweeps per second on each of the first frequency band 140 (e.g., a 2.4 GHz band), the second frequency band 144 (e.g., a 5 GHz band), or the third frequency band 148 (e.g., a 6 GHz band), or a combination thereof. The spectrum analyzer 138 may sweep all of the frequency bands of the wireless network 152 at a faster rate than using the radios 116, 118, and 120 to sweep each channel. In some embodiments, the spectrum analyzer 138 may be used to sweep the 2.4 GHz and 5 GHz frequency bands, and not the 6 GHz frequency band. In such a case, out of band discovery may be used to determine the channels in the 6 GHz frequency band.

Processing device 126 may obtain one or more measurements of the spectrum analyzer 138 at one or more frequencies. If the measurements (e.g., an RF energy level) of a frequency or frequency range satisfies a threshold, then the channel corresponding to that frequency or frequency range may be deemed to have activity.

In response to the channel having activity (using any of the techniques described), the processing device 126 may operate the one or more radios 116, 118, or 120 to sense a signal strength 136 of the channel. For example, a radio may be operated to process its respective antenna signal to sense communications over a specified channel (e.g., the channel with activity), extract data from that signal, or measure the signal strength of that signal, or both.

In the case where a radio has multiple antennas, the radio may combine the antenna signals, such as by taking the average or the strongest of the antenna signals, and using that combined signal for the measurement of the signal strength. The radio may also extract data (e.g., decode the signal) from each antenna. Thus, processing device 126 may sense a plurality of signal strengths 136, each corresponding to an active channel. Processing device 126 may skip or ignore other channels that are not deemed to have activity.

The processing device 126 may operate the one or more radios (e.g., 116, 118, and 120) to sweep each of those channels that have activity, and determine the network signal strength at each of the different plurality of frequency ranges. One radio may sense signal strength of one channel (which has been determined to have activity), while another radio simultaneously senses signal strength of another channel (which has been determined to have activity), and so on. In such a manner, the active channels may be measured quickly. The channels that are not determined to have activity may be ignored and skipped.

Computing device 132 may include a housing or enclosure 102 that houses the various components such as the one or more radios (e.g., radio 116, radio 118, and radio 120), one or more antennas (e.g., antennas 104, 106, 108, 110, 112, 114), the processing device 126, as well as other components. Each antenna may be fixed on the device 132 with a different position (e.g., with a unique direction and/or location).

In some examples, the device 132 may include an interface 122 which may include a button, a touchscreen display, a microphone, etc., to receive user inputs. Interface 122 may include a wired or wireless port to communicate from device 132 to an external device. For example, device 132 may communicate information (e.g., network signal strength) gathered by the measuring device, or be used to update the settings of the device 132, or otherwise interact with external devices. In some examples, a user may operate the device with a second device (e.g., a computer, a tablet computer, a mobile phone, etc.) that may provide user inputs to control how the processing device 126 is to determine which channels are active.

The computing device 132 may include a localizer system 134 that may determine a location of the computing device 132. The localizer system 134 may include Wi-Fi position system (WPS) which utilizes sensed characteristics (e.g., signal strength) of various access points and known locations of each access point to determine a location of the computing device. Additionally, or alternatively, the localizer system 134 may include global positioning system (GPS) to determine the location of the computing device. The location of the computing device 132 may be used in association with the sensed network signal strength 136 to map out the network signal strength 136 at various locations in a region of interest.

In some examples, the computing device 132 is a battery powered device. The device may include an energy storage system 124 which may include one or more batteries 128 that power the various components of the computing device 132. In some embodiments, the batteries may be rechargeable. In some embodiments, the batteries are single use. The computing device 132 may be a cordless device so that a user may carry the device freely throughout a given space and measure the network signal strength at various locations.

Although not shown, the device may include one or more printed circuit boards and other electronic components connected to the circuit boards. Some of the components may be integral to or distributed throughout other components.

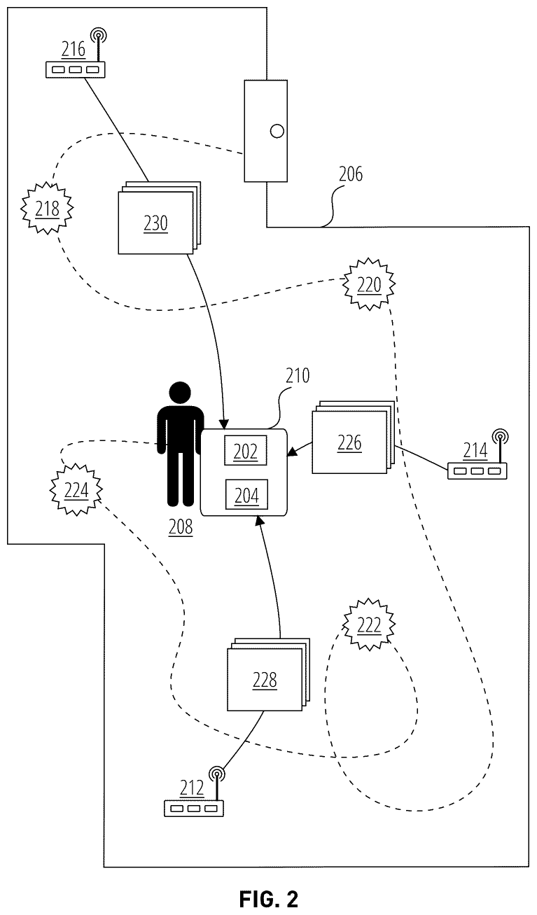

FIG. 2 shows an example of a network measurement device 210 that measures network coverage, in accordance with some embodiments. The network measurement device 210 may correspond to a computing device as described in other examples.

A user 208 may operate measurement device 210 to scan the network coverage at various locations (e.g., 218, 220, 222, and 224) in a region 206 of interest. The region 206 may be an indoor space, an outdoor space, or both. The region may include one or more access points such as access points 212, 214, and 216. Some or all of the access points may be multi-band access points. Each of the access points 212, 214, and 216 may be communicatively coupled to form a wireless network (e.g., WLAN). They may be in the same wireless network. The APs may have the same service set identifier (SSID), or different SSIDs.

A wireless network may include a plurality of frequency bands each subdivided into a plurality of channels. A channel of the wireless network may occupy a predefined (e.g., standardized) frequency range of a frequency band. For example, the 2.4 GHz frequency band may include up to 14 channels, each channel being spaced 5 MHz apart and 20 MHz wide. In the 5 GHz band, the number of channels may range from 36 up to 165 (depending on channel width). In the 6 GHz band, the number of channels may range from 1-233 (depending on channel width). The number of channels may also vary depending on other factors such as which country the network is operating in.

As described, due to the large number of available wireless network channels in a given wireless network, blindly scanning each available channel (without prior knowledge of whether it contains network activity) may be time consuming and waste resources. As such, the measurement device 210 may make use of one or more techniques to determine or estimate which channels have activity and which do not. A channel may be determined or estimated as active if an AP is communicating (or has most recently communicated) over the channel. An AP may communicate with network nodes or other APs. The measurement device 210 may be a node on the wireless network.

A user may initiate operation (e.g., scanning and measuring of signals) through one or more user inputs (e.g., a button press, etc.). Additionally, or alternatively, the device 210 may operate without user input (e.g., scanning periodically or in response to sensed movement or location, or a combination thereof). The measurement device 210 may determine which channels are active in the wireless network. The measurement device 210 may not know which APs are on the network or which channels those APs are operating on. Rather than use its radios to scan each and every available channel to find an AP, the device 210 may scan some default channels to obtain more information about which channels may be active (e.g., which channels AP 212, 214, and 216 are communicating on).

Determining whether a channel has activity may include obtaining, over a 2.4 GHz frequency band or a 5 GHz frequency band, a list of one or more channels that are active on a 6 GHz frequency band. For example, measurement device 210 may operate one or more radios 202 to passively listen on a default channel (over the 2.4 GHz or 5 GHz frequency band) for a beacon frame. AP 214 may send a communication 226 (e.g., a beacon frame) with information that AP 214 has an active channel X on its 2.4 GHz radio, an active channel Y on its 5 GHz radio, and an active channel Z on its 6 GHz radio.

Additionally, or alternatively, measurement device 210 may operate a radio to actively transmit a probe request on one or more default channels. AP 214 may send a communication 226 (e.g., a probe response frame) that similarly describes that AP 214 has an active channel X on its 2.4 GHz radio, an active channel Y on its 5 GHz radio, and an active channel Z on its 6 GHz radio. Multiple APs may answer the probe request. For example, AP 212 may also send its own communication 228 in response to the probe request that similarly describes that AP 212 has an active channel A on its 2.4 GHz radio and an active channel B on its 6 GHz radio.

As such, device 210 may use minimal scanning operations over the 2.4 GHZ and 5 GHz to obtain a list of active channels including those on the 6 GHz frequency band, without scanning each and every channel.

Additionally, or alternatively, the measurement device 210 may obtain, from an access point, a list of active channels of neighboring access point on the wireless network. Each of APs 212, 214, and 216 may communicate with each other over the wireless network and share information such as, for example, the active channels on each of its own radios. The measurement device 210 may probe a default channel (e.g., send a ‘neighbor report’ request). Any or all of the APs may receive the probe and respond. For example, AP 216 may respond to the probe with a communication 230 (e.g., a neighbor report) that includes a list of one or more active channels on AP 214, AP 218, or both.

Additionally, or alternatively, the device 210 may sweep one or more frequency bands (e.g., the 2.4 GHz frequency band, the 5 GHz frequency band, or the 6 GHz frequency band, or a combination thereof) with an onboard spectrum analyzer 204 to sense RF activity at each of the various frequencies. The measurement device 210 may determine as being active, the one or more channels that correspond to the frequencies that show a requisite level of RF energy.

In response to determining which channels are active, the device 210 may sense signal strength at various channels of interest (e.g., channels that are determined to have activity) with one or more radios 202. The device 210 may scan the signal strength of the different channels at various locations. For example, at location 218, the device 210 may determine one or more channels in the wireless network that have activity and scan those channels. The user may move to a second location 220 where another set of network signal strengths is determined for each active channel. The user may repeat this over various locations in region 206 such as locations 220, 222, and 224, until the region is sufficiently measured. Depending on the various network signal strengths measured, the user may add or move access points to cover areas with a weak signal strength, or remove an access point where coverage is sufficient. In some embodiments, the measurement device 210 may determine which channels are active at various locations and times (e.g., prior to operating the radios 202 to sense the signal strength on those one or more active channels).

In some embodiments, measurement device 210 or a remote device may associate the network signal strength with a location of the device. For example, one or more network signal strengths that are determined at location 218 may be tagged with metadata indicating location 218 (e.g., as coordinates, or a location ID, etc.) and saved in computer-readable memory. The location may be determined based on user input, localization, or a combination thereof. The network signal strengths and metadata may be stored locally, or on a remote device, or both. The network signal strengths determined at each of the locations (e.g., 220, 222, and 224) may be stored along with the location at which that network signal strength is measured to provide a mapping between signal strength and various locations in the region 206.

In some examples, a heat map of a network signal strength in region 206 is determined based on the signal strength at each of a plurality of different locations of the environment. A heat map may provide a visual indication such as variations in brightness, color, or other visual indicator which may be overlaid on a map of the region of interest, to show strength of the network signal at various locations on the map. The heat map may be presented to a display, which may be integral to the measurement device 210 or on a remote device.

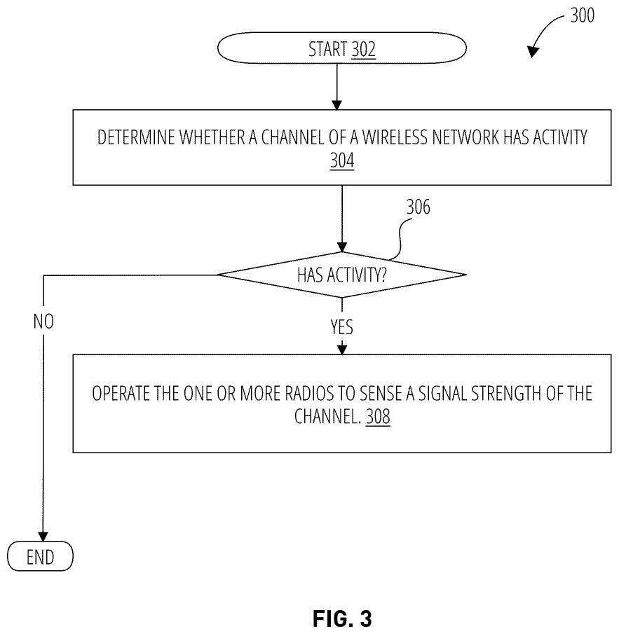

FIG. 3 illustrates a method 300 for determining a network signal strength, in accordance with some embodiments. The method may be performed with various aspects described. The method may be performed by processing logic of a measuring device that includes one or more radios. Processing logic may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof.

Although specific function blocks (“blocks”) are described in the method, such blocks are examples. That is, aspects are well suited to performing various other blocks or variations of the blocks recited in the method. It is appreciated that the blocks in the method may be performed in an order different than presented, and that not all of the blocks in the method may be performed.

At block 302, processing logic may initiate a scan of a region. This may be in response to a user input, a remote command, automated logic, or a combination thereof.

At block 304, processing logic determines whether a channel of a wireless network has activity. Processing logic may operate one or more radios of the device to use an out-of-band discovery protocol to determine that the channel has activity. Additionally, or alternatively, processing logic may obtain a list of active channels of neighbor APs to determine that the channel has activity. Additionally, or alternatively, processing logic may operate a spectrum analyzer to scan a plurality of channels to sense that the channel has activity. Processing logic may use one or more techniques to determine which of the channels of the wireless network have activity.

At block 306, if the channel has activity, processing logic may proceed to block 308. If the channel does not have activity, processing logic may skip this channel and not scan it with its radios. If no channels have activity, processing logic may proceed to end the method, assuming that no active signal is present to measure.

At block 308, processing logic may operate the one or more radios to sense a signal strength of the channel. The process may be repeated to determine the signal strength of each channel that has activity. The process may also be repeated over various locations of a region to determine coverage of the wireless network over the region.

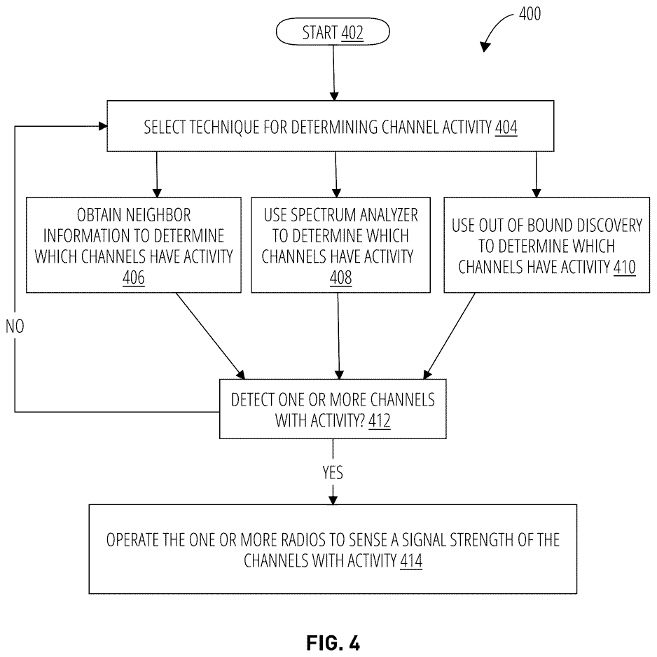

FIG. 4 illustrates a method 400 for determining a network signal strength with various techniques, in accordance with some embodiments. The method may be performed with various aspects described. The method may be performed by processing logic of a measuring device that includes one or more radios. Processing logic may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof.

Although specific function blocks (“blocks”) are described in the method, such blocks are examples. That is, aspects are well suited to performing various other blocks or variations of the blocks recited in the method. It is appreciated that the blocks in the method may be performed in an order different than presented, and that not all of the blocks in the method may be performed.

At block 402, processing logic may initiate a scan of a region. This may be in response to a user input, a remote command, automated logic, or a combination thereof.

At block 404, processing logic may select a technique for determining channel activity. Processing logic may select one or more of blocks 406, 408, or 410 to determine one or more channels that have activity. The selection may be done in view of one or more factors. In some embodiments, processing logic selects at least one of blocks 406, 408, or 410 to determine one or more channels that have activity. For example, processing logic may determine the one or more channels that have activity based on at least one of: an out-of-band discovery communication from an AP (block 410), obtaining neighboring AP information from an AP (block 406), or scanning with a spectrum analyzer (block 408).

In some examples, one or more settings such as user preferences or default settings may define which of the blocks to use to determine the active channels. Settings may be stored on the device, or remotely, or both. Additionally, or alternatively, the device may receive user input (e.g., through a user interface) and select one of the blocks based on the user input.

In some examples, processing logic may select a technique based on energy storage of the measuring device. For example, the energy storage may have less than a threshold amount of stored electrical energy. In response, processing logic may select one or more techniques that use less energy. In some examples, processing logic may select block 406 (e.g., obtaining a neighbor report) or block 410 (e.g., using out of bound discovery), or both, instead of block 408 (e.g., the spectrum analyzer), to conserve energy.

In some examples, processing logic may select block 406 if it is in communication with a first AP. Processing logic may request neighbor information from the first AP to obtain one or more active channels of neighboring APs. Processing logic may also communicate with the first AP, and neighboring APs once their active channels are obtained, to use out of bound discovery to determine active channels on other frequency bands (e.g., a 6 GHz frequency band). If processing logic has no knowledge of APs in the network, it may fall back to scanning channels with a spectrum analyzer to sense which channels have activity, or listening for a beacon frame on a default channel, or both. Processing logic may select one, two, or all three of the blocks 406, 408 and 410 to detect one or more channels with activity. In some examples, if processing logic is unable to determine one or more active channels using block 406, block 410, or both, processing logic may fall back on block 408.

At block 412, processing logic may proceed to block 414 if active channels are detected. If none are detected, processing logic may return to block 404 and select a different block to detect one or more active channels.

At block 414, processing logic may operate the one or more radios to sense a signal strength of each of the one or more channels with activity. The channels that are not determined as active may be ignored and not sensed by the one or more radios.

In such a manner, processing logic may obtain the network signal strength in an efficient manner by implementing one or more techniques (e.g., at blocks 406, 408, and 410). Processing logic may select which technique to use based on various considerations, as described.

Some portions of the preceding detailed descriptions have been presented in terms of algorithms and symbolic representations of operations on data bits within a computer memory. These algorithmic descriptions and representations are the ways used by those skilled in the arts to most effectively convey the substance of their work to others skilled in the art. An algorithm is here, and generally, conceived to be a self-consistent sequence of operations leading to a desired result. The operations are those requiring physical manipulations of physical quantities. It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computing device, that manipulates and transforms data represented as physical (electronic) quantities within the system's registers and memories into other data similarly represented as physical quantities within the system memories or registers or other such information storage, transmission or display devices.

In some aspects, this disclosure may include the language, for example, “at least one of [element A] and [element B].” This language may refer to one or more of the elements. For example, “at least one of A and B” may refer to “A,” “B,” or “A and B.” Specifically, “at least one of A and B” may refer to “at least one of A and at least one of B,” or “at least of either A or B.” In some aspects, this disclosure may include the language, for example, “[element A], [element B], and/or [element C].” This language may refer to either of the elements or any combination thereof. For instance, “A, B, and/or C” may refer to “A,” “B,” “C,” “A and B,” “A and C,” “B and C,” or “A, B, and C.”

While certain aspects have been described and shown in the accompanying drawings, it is to be understood that such aspects are merely illustrative of and not restrictive, and the disclosure is not limited to the specific constructions and arrangements shown and described, since various other modifications may occur to those of ordinary skill in the art.

1. A device, comprising:
one or more radios; and
a processing device, configured to:
determine whether a channel of a wireless network has activity, and
in response to the channel having the activity, operate the one or more radios to sense a signal strength of the channel.

2. The device of claim 1, wherein to determine whether the channel has activity includes obtaining, over a 2.4 GHz frequency band or a 5 GHz frequency band, a list of one or more channels that are active on a 6 GHz frequency band.

3. The device of claim 1 , wherein obtaining the list of the one or more channels includes obtaining a beacon frame from an access point over the 2.4 GHz frequency band or the 5 GHz frequency band, the beacon frame including the list of one or more active channels on the 6 GHz frequency band.

4. The device of claim 1, wherein the one or more radios are operated to sense the signal strength of the channel on the 6 GHz frequency band without sensing the signal strength of inactive channels on the 6 GHz frequency band.

5. The device of claim 1, wherein to determine whether the channel is active includes obtaining, from an access point, a list of active channels of neighboring access point on the wireless network.

6. The device of claim 1, further comprising a spectrum analyzer, wherein to determine whether the channel is active includes sweeping one or more frequency bands with the spectrum analyzer to determine that the channel in the one or more frequency bands has activity.

7. The device as in any one of claim 1, wherein the processing devices is configured to sense a signal strength on a default set of channels.

8. The device as in any one of claim 1, wherein the one or more radios are operated to ignore one or more second channels in response to determining that the one or more second channels do not have activity.

9. The device as in any one of claim 1, the wireless network is a wireless local area network (WLAN).

10. The device of claim 1, wherein the device is a portable device.

11. A method, performed by a network measurement tool having one or more radios, the method comprising:
determining whether a channel of a wireless network has activity; and
in response to the channel having the activity, operating the one or more radios to sense a signal strength of the channel.

12. The method of claim 11, wherein to determine whether the channel has activity includes obtaining, over a 2.4 GHz frequency band or a 5 GHz frequency band, a list of one or more channels that are active on a 6 GHz frequency band.

13. The method as in any one of claim 11, wherein obtaining the list of the one or more channels includes obtaining a beacon frame from an access point over the 2.4 GHz frequency band or the 5 GHz frequency band, the beacon frame including the list of one or more active channels on the 6 GHz frequency band.

14. The method as in any one of claim 11, wherein the one or more radios are operated to sense the signal strength of the channel on the 6 GHZ frequency band without sensing the signal strength of inactive channels on the 6 GHZ frequency band.

15. The method as in any one of claim 11, wherein to determine whether the channel is active includes obtaining, from an access point, a list of active channels of neighboring access point on the wireless network.

16. The method as in any one of claim 11, further comprising a spectrum analyzer, wherein to determine whether the channel is active includes sweeping one or more frequency bands with the spectrum analyzer to determine that the channel in the one or more frequency bands has activity.

17. The method as in any one of claim 11, wherein the processing devices is configured to sense a signal strength on a default set of channels.

18. The method as in any one of claim 11, wherein the one or more radios are operated to ignore one or more second channels in response to determining that the one or more second channels do not have activity.

19. (canceled)

20. The method as in any one of claim 11, wherein the signal strength is associated with a location at which the network measurement tool measures the signal strength, and the signal strength and the location are presented on a display.

21. (canceled)

22. A non-transitory computer readable medium comprising instructions which, when executed by an apparatus, cause the apparatus to at least carry out:
determining whether a channel of a wireless network has activity; and
in response to the channel having the activity, operating the one or more radios to sense a signal strength of the channel.

23. (canceled)

24. (canceled)
